(19) United States
(12) Patent Application Publication
(10) Pub. No.: US 2024/0344392 A1
(43) Pub. Date: Oct. 17, 2024

(54) Extension Ladder Accessory

(71) Applicant: Werner Co., Greenville, PA (US)

(72) Inventor: John Maher, Crystal Lake, IL (US)

(21) Appl. No.: 18/634,391

(22) Filed: Apr. 12, 2024

Related U.S. Application Data
(60) Provisional application No. 63/459,135, filed on Apr. 13, 2023.

(51) Int. Cl. E06C 1/12; E06C 7/00

(52) U.S. Cl. CPC E06C 1/12; E06C 7/00

(57) ABSTRACT

An extension ladder including a base section and a fly section. The fly section is slidably engaged with the base section. The extension ladder includes a ladder descent accessory which counteracts at least a portion of the weight of the fly section as the fly section is lowered relative to the base section.

### CROSS-REFERENCE TO RELATED APPLICATION(S)

This application claims the benefit of U.S. Provisional Application No. 63/459,135, filed Apr. 13, 2023, which is incorporated herein by reference in its entirety.

### FIELD OF THE DISCLOSURE

The present disclosure relates to extension ladders and extension ladder accessories, and more specifically to extension ladder accessories which aid in controlling adjustments of extension ladders.

### BACKGROUND

Extension ladders generally include a fly section slidably engaged with a base section to extend the length of the extension ladder. During retraction of the extension ladder, the fly section typically moves in a substantially downward direction. This movement typically requires the user to control the weight of the fly section as gravity acts on the fly section moving downward. If the user is unable to control the weight of the fly section, the fly section may slide downward at an increased rate of speed. Improper usage causing the fly section to slide down the base section at an increased rate may potentially damage the extension ladder.

### BRIEF DESCRIPTION OF THE DRAWINGS

Disclosed herein are embodiments of accessories and apparatuses pertaining to providing controlled adjustment of a section of an extension ladder.

FIG. 1A is a perspective view of a ladder with a controlled adjustment accessory, the ladder in an extended state in accordance with various embodiments;

FIG. 1B is a perspective view of the ladder of FIG. 1A in a retracted state;

FIG. 2 is a partial, front view of a portion of the ladder of FIG. 1A;

FIG. 3 is a partial, perspective view of a portion of the ladder of FIG. 1;

FIGS. 4A to 4C are detail views of portions of elements of the controlled adjustment accessory of FIG. 1;

FIG. 5A is a perspective view of a ladder including a controlled adjustment accessory in accordance with various embodiments;

FIG. 5B is a partial view of a portion of the ladder of FIG. 5A;

FIG. 6 is a perspective view of a ladder including the controlled adjustment accessory of FIGS. 5A and 5B in a disengaged state in accordance with various embodiments;

FIG. 7 is a perspective view of a ladder including the controlled adjustment accessory of FIGS. 5A and 5B in an engaged state in accordance with various embodiments;

FIG. 8 is a cross-sectional view of the controlled adjustment accessory of FIGS. 5A and 5B disengaged from a portion of the ladder in accordance with various embodiments;

FIG. 9 is a cross-sectional view of the controlled adjustment accessory of FIGS. 5A and 5B engaged with a portion of the ladder in accordance with various embodiments;

FIG. 10A is a perspective view of a ladder including a controlled adjustment accessory in accordance with various embodiments;

FIG. 10B is a partial view of a portion of the ladder including a controlled adjustment accessory of FIG. 10A in accordance with various embodiments;

FIG. 11A is a partial view of a portion of the ladder adjustment accessory of FIGS. 10A and 10B in accordance with various embodiments;

FIG. 11B is cross-sectional view of the ladder adjustment accessory of FIGS. 10A and 10B in accordance with various embodiments; and

FIG. 11C is an exploded view of the ladder adjustment accessory of FIGS. 10A and 10B in accordance with various embodiments.

### DETAILED DESCRIPTION

The present disclosure relates to ladders and accessories used therewith such as a controlled adjustment mechanism. By one approach, a controlled adjustment mechanism or accessory includes a controlled adjustment mechanism that is configured to slow the rate of descent of a portion (e.g., an extension fly) of an extension ladder. For example, by providing a mechanism to control the speed of descent of the extended section of the extension ladder (such as the extension fly), the ladder is typically easier and safer to use. In addition, such controlled adjustment mechanisms may help avoid damage to the ladder itself during use.

By some approaches, the controlled adjustment mechanism such as the ladder descent accessories described herein, may be disposed on a base section of the extension ladder. In one illustrative approach, a ladder descent accessory includes a friction brake disposed on the base section in a manner such that the friction brake is configured to engage a fly section of the extension ladder. More particularly, in one installation the friction brake engages the fly section as it moves downward relative to the base section. In this way, the friction brake is further configured to reduce the speed of descent of the fly section.

In some embodiments, a friction brake includes a housing coupled to a base section (e.g., at an upper end), a brake arm positioned at least partially within the housing at a first end, and a friction pad disposed at a second end, opposite the first end, of the brake arm.

The friction brake also may further include a spring disposed adjacent or within the brake arm and is configured to engage when the fly section moves downward relative to the base section. Further, a pin may be disposed within an opening in the brake arm such that the pin moves between an engaged position and a disengaged position within the opening.

Depending on the size, weight, and configuration of the extension ladder, multiple friction breaks may be employed with an extension ladder. In some configurations, a second friction brake may be utilized at a second location along the base section. In some configurations, this may include, a second friction brake being disposed below the first friction brake. Further, the second friction break may be aligned with or disposed on the same side as the first friction brake. This may also include, for example, the second friction brake being disposed on a second and a side opposite the first friction brake. When the second friction brake is disposed on the second side, the second friction brake may be disposed at a similar location as the first friction brake or a different location, above or below the first friction brake.

The ladders, components, and/or accessories described herein may be formed of a variety of materials and using a variety of manufacturing techniques. Such materials may include, e.g., metals, plastics, and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

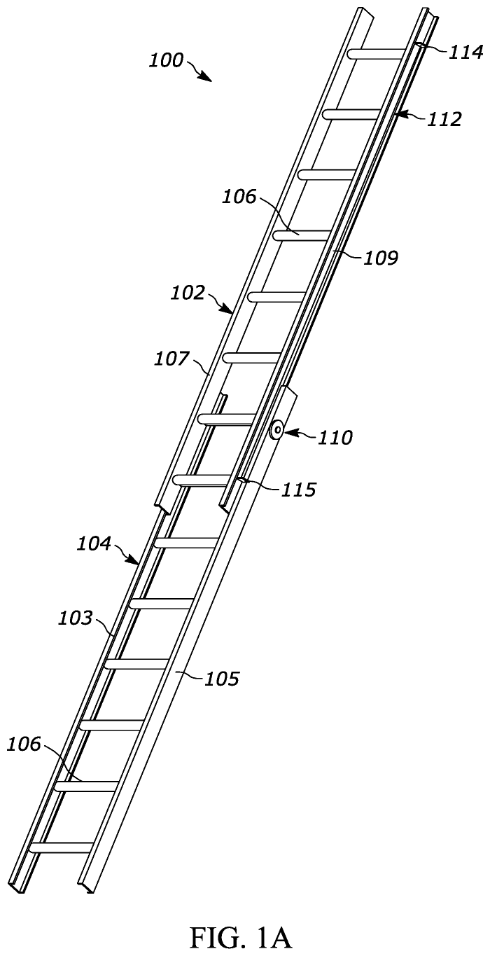

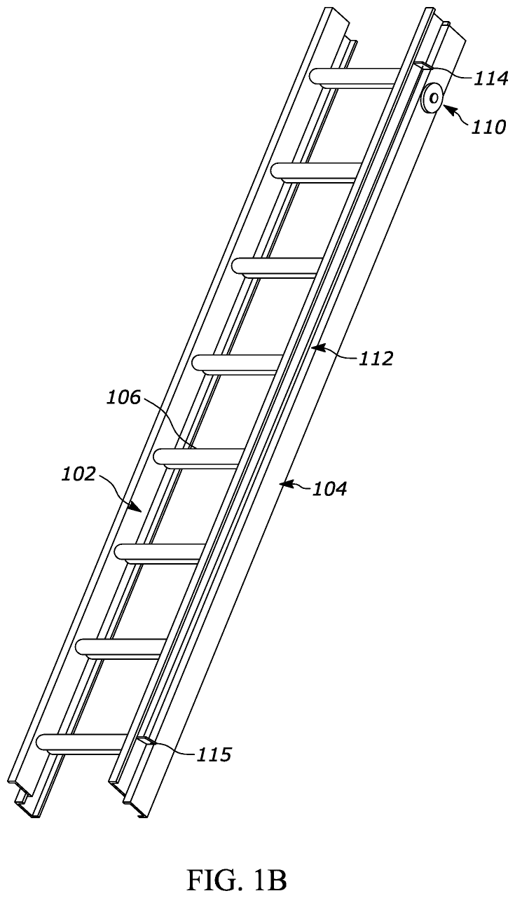

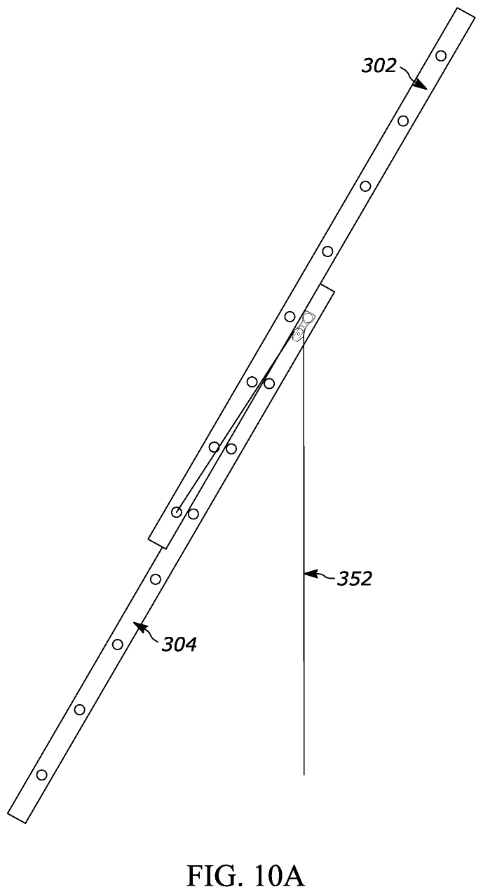

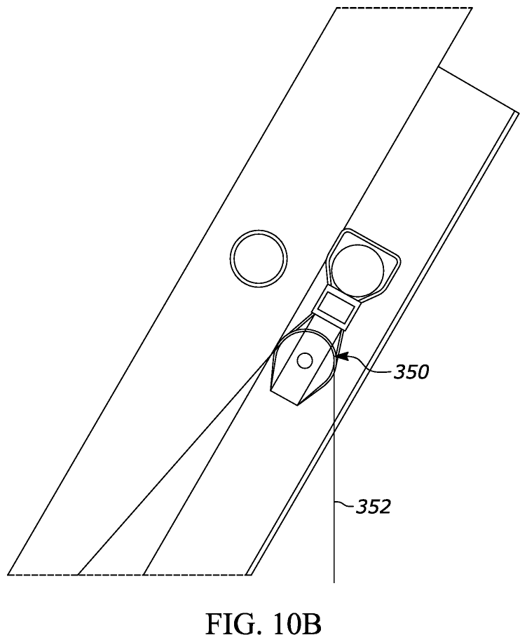

Referring now to the drawings, and more specifically to FIGS. 1 to 4C, which illustrates an extension ladder 100 including ladder control adjustment accessories or a controlled descent mechanism. The extension ladder 100 includes a base section 104 having a first base rail 103 and a second base rail 105 in parallel and spaced relationship with the first base rail 103 and the second base rail connected via a plurality of base rungs 106. The extension ladder 100 includes a fly section 102 having a first fly rail 107 and a second fly rail 109 in parallel and spaced relationship with the first fly rail 107 and the second fly rail connected via a plurality of fly rungs 106. The fly section 102 is slidably coupled to or engaged with the base section 104. The fly section 102 includes an associated weight, such as a fly weight. Additionally, in some embodiments, the extension ladder 100 includes a hoist rope 152, as shown in FIG. 10A, attached to the base section 104 and the fly section 102 to help raise and lower, extend and retract, the fly section 102 relative to the base section 104.

In some configurations, the extension ladder 100 includes a rotary damper assembly 110 coupled to the base section 104, where the rotary damper assembly 110 is configured to help control movement of the fly section 102 relative to the base section 104. For example, the rotary damper assembly 110 may provide resistance or torque to control the movement of the fly section. In other words, the rotary damper assembly 110 counteracts at least a portion of the fly weight when the fly section 102 is being retracted or lowered relative to the base section 104.

In one exemplary embodiment, the rotary damper assembly 110 includes a damper cable 112 attached to the fly section 102 at upper attachment point 114 and a lower attachment point 115. The rotary damper assembly 110 also may include a rotary damper drum 116 mounted on the base section 104, such as near the top of the base section 104. The rotary damper assembly 110 typically includes a cable drum 122, around which the damper cable 112 wraps. In use, the cable drum 122 is permitted to rotate substantially unresisted in one direction as the fly section 102 is extended, or raised, relative to the base section 104. Then, the cable drum 122 is configured to provide resistance when rotating during retraction, or lowering, of the fly section 102 relative to the base section. Accordingly, in one direction the cable 112 is permitted to easily or freely extend or operate and in the other direction the winding, operation or movement of the cable 112 is metered such that the movement is governed by the rotary damper assembly 110.

By some approaches, the rotary damper assembly 110 also includes a contact shaft 118 connecting the rotary damper drum 116 to the cable drum 122. Further, a one-way clutch 124 may be attached to the cable drum 122 and a shaft 120. In some approaches, the one-way clutch 124 is disposed within the contact shaft 118. As the fly section 102 is retracted, the fly section 102 rotates the contact shaft 118 which causes the damper cable 112 to spool onto the cable drum 122. Additionally, the rotation of the contact shaft 118 rotates the rotary damper drum 116. In operation, the rotation of the rotary damper drum 116 provides a friction force to slow the descent speed of the fly section 102. The rotary damper drum 116 may be similar to those known in the art. Accordingly, the rotary damper drum 116 may provide an internal friction due to a plurality of fins or other elements rotating through a viscous liquid which in turn slows the descent speed of the fly section 102.

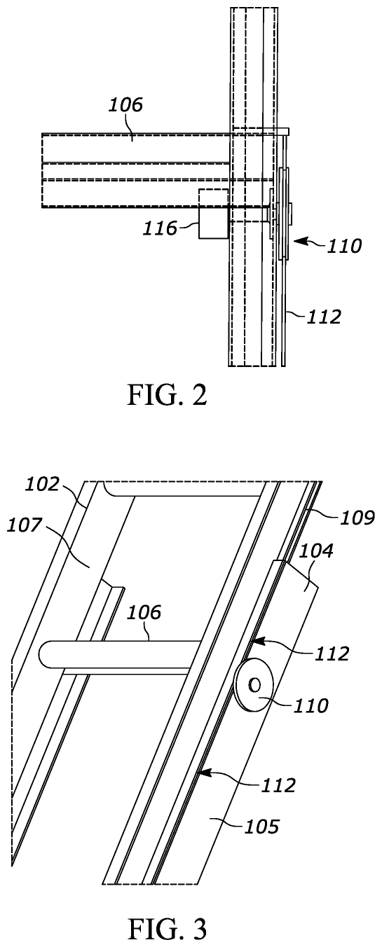

Further, FIGS. 1A and 1B show an extension ladder 100 in the fully extended and fully retracted positions. A cable 112 is attached to the fly section 102 at upper attachment point 114 and a lower attachment point 115. This cable 112 wraps at least one tum around the cable drum 122 of a rotary damper assembly 110. The rotary damper assembly 110 is mounted on the base section 104 near the top. FIG. 2 illustrates the position of the descent accessory.

In some configurations, the rotary damper assembly 110 may include one or more fixed members (such as plates or fins), and one or more moving members (such as plates or fins) in a housing or casing. In addition, in some embodiments the rotary damper assembly 110 may include a liquid contained in the housing or casing. When the fly section 102 is being retracted, the moving plates are permitted to spin while the fixed plates stay in place. As the fly section 102 is retracted, the moving plates rotate and are affected by the friction created by rotating the moving plates in the liquid inside of the rotary damper assembly 110. The viscosity of the liquid can be chosen based on certain climates, temperatures, conditions, and weights of the fly section 102.

Coupling a one-way clutch 124 with the rotary damper assembly 110 allows for the use of the rotary damper assembly 110 only when the fly section 102 is being retracted. FIG. 3 shows the cable 112 and the cable drum 122 relationship more clearly, in a simplified form without certain elements (such as a side plate). In some configurations, the cable drum 122 may additionally or alternatively contact the fly section 102 as the fly section 102 is retracted. In this way, similar to as described above with regard to the rotation of the contact shaft 118 caused by the retracting of the fly section 102, the rotary damper drum 116 is rotated and provides the internal friction to slow the descent speed of the fly section 102. Further, in some configurations, the one-way clutch 124 may slide in and out of contact with the fly section 102.

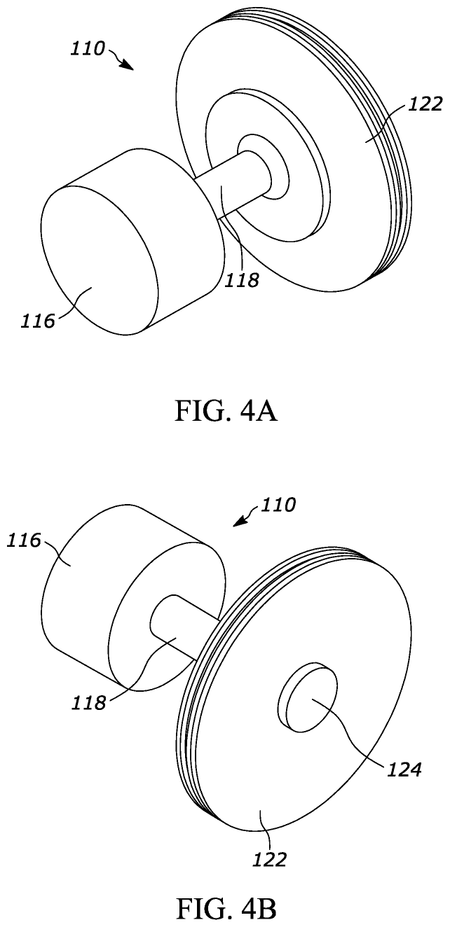

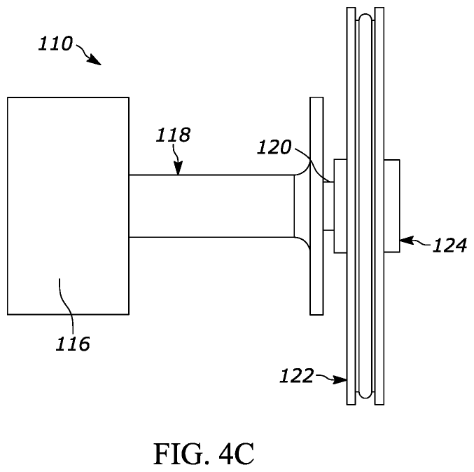

FIGS. 4A to 4C show the major component parts of one illustrative rotary damper assembly 110. A contact shaft 118 supports the components and attaches the unit to the web of a base rail. As shown, the cable drum 122 is connected to the shaft 120 via a one-way clutch 124. This clutch 124 allows the cable drum 122 to turn freely in one direction but compels the cable drum 122 to turn the shaft when rotating in the opposite direction. as shown, the shaft 120 is connected or coupled to the rotary damper assembly 110. The rotary damper assembly 110 may resist rotation due to a variety of factors. These may include, for example, (1) dry friction between rotating and fixed or stationary members, (2) fluid friction related to viscous fluid shear between the fluid and the members disposed in the clutch. In yet other embodiments, the rotary damper assembly 110 may utilize passive electromagnetic devices. In this manner, the rotary damper assembly 110 may be an eddy current damper that resist rotation due to the eddy current braking action between rotating components and stationary permanent magnets.

In operation, as the fly section 102 is raised, the damper cable 112 causes the cable drum 122 to rotate but the one-way clutch 124 allows the shaft 120 to remain stationary. Thus, the user encounters no resistance other than the weight of the fly section 102. When the fly section 102 is lowered, the one-way clutch 124 causes the shaft 120 to rotate with the cable drum 122. The rotary damper assembly 110 connected to the shaft 120 provides torque which counteracts some fraction of the fly section's weight.

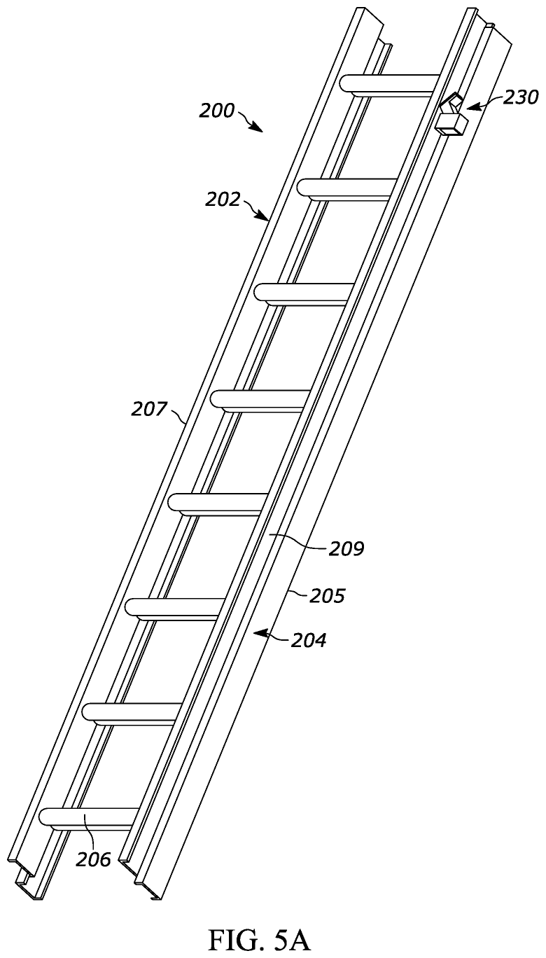

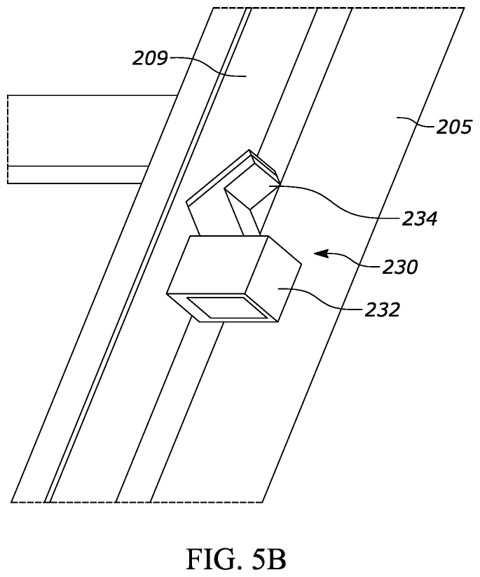

Referring to FIGS. 5A to 9, a ladder descent accessory, such as a friction brake 230, is shown coupled to the extension ladder 200. As described above, an extension ladder 200 typically includes a base section 204, including a first base rail 203 and a second base rail 205, a fly section 202, including a first fly rail 207 and a second fly rail 209, slidably engaged with the base section 204, and a plurality of rungs extending between corresponding base rails and fly rails. The friction brake 230 is disposed on a portion of the base section 204. The friction brake 230 typically includes a housing 232 coupled to the base section 204, or a side thereof.

By some approaches, the friction brake 230 also includes a brake arm 234 connected to and positioned at least partially inside of the housing 232 at a first end. The friction brake 230 further includes a friction pad 236 disposed on a second end of the brake arm 234, opposite the first end, a spring 238 disposed within the brake arm 234, and a pin 240 disposed within an opening 242 in the brake arm 234. The pin 240 is coupled to at least a portion of the housing 232 such that the opening 242 moves relative to the pin 240 when the friction brake 230 is engaged.

In the disengaged state the friction pad 236 makes minimal contact with the fly section 202. The disengaged state may include the fly section 202 while it is being extended outward/upward, and when the fly section 202 is stationary relative to the base section 204 (e.g., when fully retracted and fully extended and locked into position). On the other hand, in the engaged state, the friction pad 236 contacts the fly section 202, such as a side thereof, to provide friction to the movement of the fly section 202. In this manner, the friction pad 236 helps control and slow the descent speed of the fly section 202 as it is retracted downward. The engaged state typically includes while the fly section 202 is being retracted relative to the base section 204.

In some embodiments, the friction brake 230 includes a disengaged position where the brake arm 234 is disposed substantially parallel to the side of the fly section 202. In this way, the brake arm 234 can be moved into the disengaged position such that the friction pad 236 makes no contact with the fly section 202, and retraction of the fly section 202 does not cause engagement of the friction brake 230 with the fly section 202. In this way, in certain conditions, such as wet or humid conditions, the friction brake 230 can be disengaged to avoid potential complications caused by the weather or weather conditions. To return the friction brake 230 to the engaged position, the brake arm 234 is rotated downward such that a portion of the friction pad 236 contacts the fly section 202.

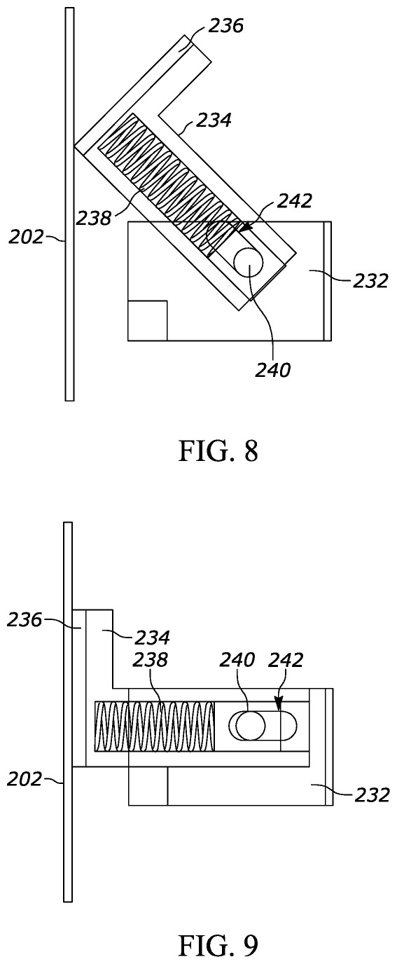

In use, as the fly section 202 is extended upward relative to the base section 204, the friction brake 230 is pushed upward such that the friction pad 236 makes minimal contact with a surface of the fly section 202, as seen in FIG. 8, and in turn, allows the pin 240 to have minimal to no contact with the spring 238. As the fly section 202 is retracted, the brake arm 234 is rotated downward due to the friction created between the fly section 202 and the friction pad 236, as seen in FIG. 9. As the brake arm 234 moves downward, the opening 242 moves relative to the pin 240 such that the pin 240 contacts the spring 238 and provides a friction force along the fly section 202, and in turn, slows descent speed of the fly section 202. The brake arm 234, and the opening 242 thereof, rotate about the pin 240.

The material of the friction pad 236 and/or the spring aspects can be selected or adjusted to customize the ladder accessory. For example, the material may be changed to account for the weight of the fly section 202, the weather conditions, including any precipitation, temperature, or humidity, the extension ladder 200 is typically used in. Similarly, the spring 238 may be changed or selected accordingly to ladder or usage details. In this way, a certain coefficient of kinetic friction can be achieved to allow for the desired or proper descent of the fly section 202 without stopping the descent of the fly section 202 completely. The friction pad 236 may be a non-destructive material such that the friction created by the friction pad 236 on the fly section 202 does not substantially remove any material off of the fly section 102. For example, the friction pad 236 may comprise one of a rubber material, a plastic or other polymer-based material, a ceramic material, carbon fiber, a combination thereof, or other industry standard materials.

In some embodiments, the friction pad 236 may be removable from the brake arm 234. In this manner, the friction pad 236 can be changed over time in light of normal wear or to account for different uses of the ladder. The friction pad 236 may be, for example, rubber or plastic, and may be selected to provide proper friction on the fly section 202 to slow the descent speed of the fly section 202 without stopping the descent. Additionally, in some embodiments, the friction pad 236 may include at least two different materials to provide the proper friction. Further, in some embodiments, the friction pad 236 may be textured to provide the proper friction. The texture may include grooves, pebbling, bumps, protrusions, intrusions, and/or other features formed into or out of the surface of the friction pad 236.

In some embodiments, a second friction brake may be utilized on a second portion of the base section 204. The second friction brake may be disposed on the same side as the friction brake 230, such as a lower position to provide additional friction as the fly section 202 gets closer to the ground. In yet other embodiments, the second friction brake may be disposed on the opposite side of the friction brake 230. This may include the second friction brake being at substantially the same height along the base section 204 or a different height. The second friction brake allows for the use of a second, different, material for the friction pad 236 such that each friction pad may be used for particular weather conditions. For example, one of the friction brake 230 or the second friction brake can include a higher friction material for instances where the extension ladder 200 is being used in the rain. To avoid potential issues caused by the other friction brake, the other friction brake may be moved into the disengaged state, as described above. In this way, the two friction brakes allow for additional use of the present disclosure in differing weather conditions.

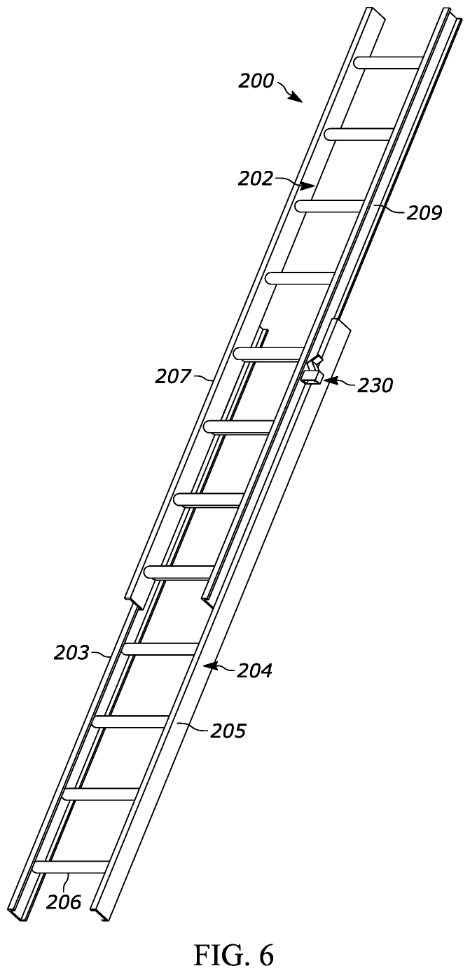

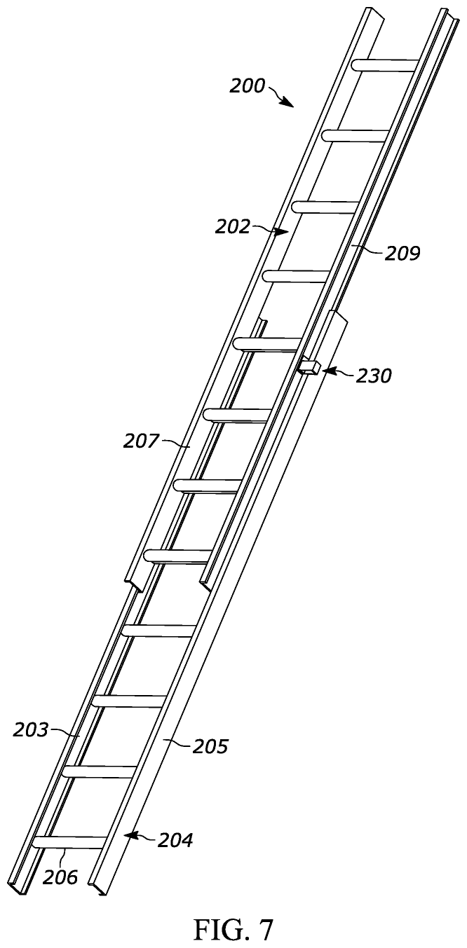

As suggested above, FIGS. 5A and 5B show another embodiment consisting of a friction brake 230 attached to the base section 204 which is disengaged from the fly section 202 while the fly section 202 is being raised but engages the fly section 202 when the fly section 102 is lowered. This engagement produces a force which opposes some fraction of the fly section's weight when the fly section 202 is lowered. FIG. 6 shows the friction brake 230 disengaged while the fly section 202 is rising. FIG. 7 shows the friction brake 230 engaged while the fly section 202 is lowered. FIGS. 8 and 9 show the internal components and the operation of the friction brake 230 when disengaged and engaged. The spring 238 is sized so that the friction brake 230 will not apply enough force to stop the fly section 202 from descending but enough force to partially offset the fly weight.

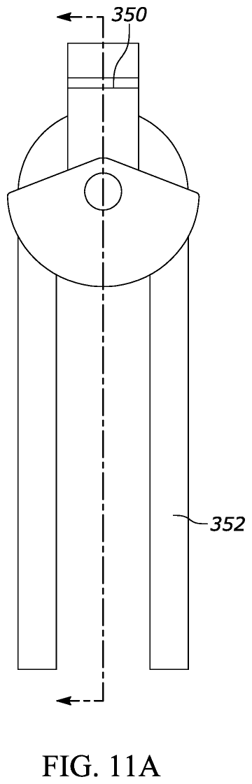

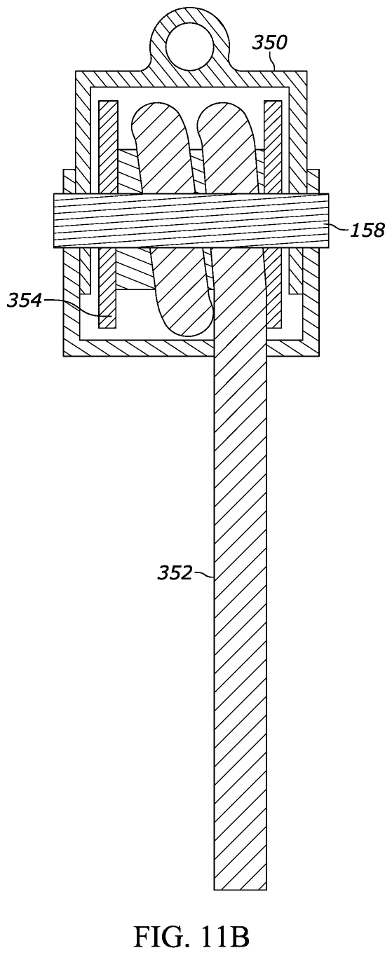

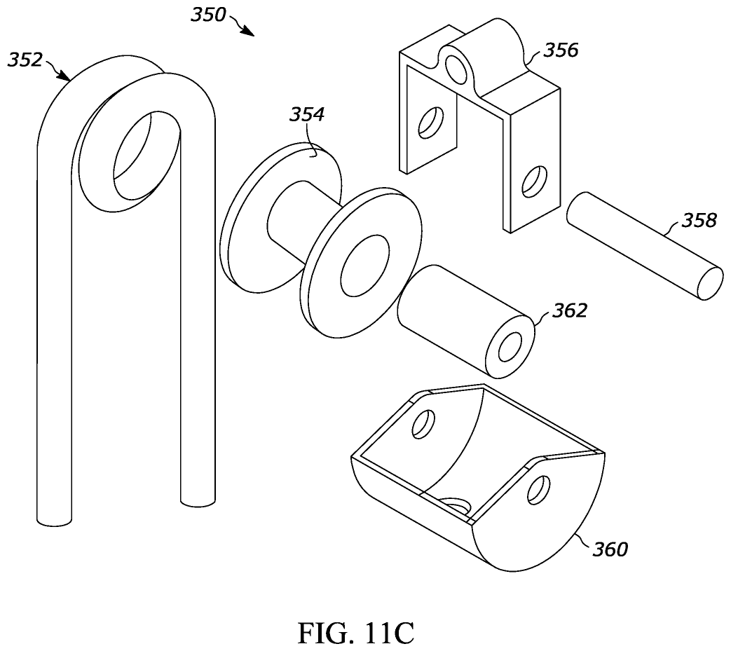

Referring to FIGS. 10A and 10B, a conventional hoist rope pulley and its position on an extension ladder 300 is shown. FIGS. 11A and 11B show another embodiment consisting of a design of a pulley 350 to replace the conventional pulley. It is attached to a base rung in place of the conventional pulley. FIG. 11C shows various views of the elements of the pulley 350 in an exploded view.

Further, referring to FIGS. 11A to 11C, in some configurations, the ladder descent accessory may include, leverage, or be disposed in the pulley 350. In such approaches, an axle 358 may be coupled or fixed to a frame 356 of the pulley 350 and a one-way brake 362 fixed to a sheave 354 of the pulley 350. In operation, the sheave 354 rotates in only one direction, when the fly section 302 moves upwards relative to the base section 304 but is stationary and prevented from rotating in an opposite direction when the fly section 302 moves down relative to the base section 304. This is due to the one-way brake 362 that engages the stationary sheave 354, which necessitates the hoist rope 352 sliding around the stationary sheave 354, creating friction between the hoist rope 352 and the stationary sheave 354. More particularly, the resistance of the hoist rope 352 results from it sliding around the stationary sheave 354. This friction reduces a force necessary for a user to apply to the hoist rope 352 to lower the fly section 302.

In some installations, the axle 358 is fixed to the frame 356. In addition, the one-way brake 362 is fixed to the sheave 354. This arrangement permits the sheave 354 to rotate in one direction but is prevented from rotating the opposite way due to the one-way brake 362 engaging the stationary sheave 354. To raise the fly section 302, the user pulls down on the free end of the hoist rope 352. The sheave 354 rotates freely, allowing the fly section 302 to be raised with little resistance besides the fly weight. When lowering the fly section 302, the sheave 354 is prevented from rotating, which necessitates that the hoist rope 352 slide around the now stationary sheave 354. The friction between the hoist rope 352 and the stationary sheave 354 provides resistance. This snubbing action greatly reduces the force which the user applies to the hoist rope 352 to safely lower the fly section 302. FIG. 11C shows the hoist rope 352 making one and a half turns around the sheave 354. However, the sheave 354 material could be chosen so that only one half turn of the hoist rope 352 is required. In one embodiment, a gas tension spring may be used to provide the counteracting force.

The ladder descent accessories described herein do not substantially change the force required to extend the fly section, however other such mechanisms may be leveraged for such functionality. The extension ladders may include a conventional hoist rope to extend or retract the fly section relative to the base section. The fly section also may be extended or retracted by pulling or paying out the hoist rope in a conventional manner. The descent accessories described herein offset at least a portion of the fly weight during the retraction of the fly section 102.

Those skilled in the art will recognize that a wide variety of modifications, alterations, and combinations can be made with respect to the above-described embodiments without departing from the scope of the disclosure, and that such modifications, alterations, and combinations are to be viewed as being within the ambit of the disclosed concept.

1. An extension ladder comprising:
a fly section including a plurality of fly rungs;
a base section including a plurality of base rungs, the fly section slidably engaged with the base section; and
a friction brake disposed on a first portion of the base section, the friction brake configured to engage the fly section as the fly section moves downward relative to the base section, the friction brake further configured to reduce a speed of descent of the fly section.

2. The extension ladder of claim 1, wherein the friction brake includes a housing coupled to the base section, a brake arm positioned at least partially within the housing at a first end, and a friction pad disposed at a second end, opposite the first end, of the brake arm.

3. The extension ladder of claim 2, wherein the friction brake further includes a spring disposed within the brake arm and configured to engage when the fly section moves downward relative to the base section.

4. The extension ladder of claim 3, wherein the friction brake further includes a pin coupled to the housing and configured to contact the first end of the spring.

5. The extension ladder of claim 4, wherein the pin is disposed within an opening in the brake arm and moves between an engaged position and a disengaged position within the opening.

6. The extension ladder of claim 2, wherein the friction pad is removable from the second end of the brake arm.

7. The extension ladder of claim 2, wherein the friction pad is one of rubber or plastic.

8. The extension ladder of claim 2, wherein the friction pad is textured.

9. The extension ladder of claim 2, wherein the friction pad includes at least two different materials to provide friction to the fly section.

10. The extension ladder of claim 2, wherein the housing is disposed at an upper end of the base section.

11. The extension ladder of claim 2, further comprising a second friction brake disposed on a second portion of the base section.

12. The extension ladder of claim 11, wherein the second portion of the base section is below the first portion.

13. The extension ladder of claim 11, wherein the second portion of the base section is opposite from the first portion.

14. The extension ladder of claim 11, wherein the second friction brake includes a second friction pad, and the second friction pad is a different material than the friction pad.

15. A ladder descent accessory comprising:
a housing;
a brake arm positioned at least partially within the housing at a first end;
a friction pad disposed at a second end, opposite the first end, of the brake arm;
a spring disposed within the brake arm; and
a pin coupled to the housing and configured to contact the first end of the spring.

16. The ladder descent accessory of claim 15, wherein the pin is disposed within an opening in the brake arm and moves between an engaged position and a disengaged position within the opening.

17. The ladder descent accessory of claim 15, wherein the friction pad is removable from the second end of the brake arm.

18. The ladder descent accessory of claim 15, wherein the friction pad is rubber.

19. The ladder descent accessory of claim 15, wherein the friction pad is plastic.

20. The ladder descent accessory of claim 15, wherein the friction pad includes at least two different materials.
